(19) United States
(12) Patent Application Publication
(10) Pub. No.: US 2018/0066638 A1
(43) Pub. Date: Mar. 8, 2018

(54) HIGH PRESSURE PUMP

(71) Applicant: Carlisle Fluid Technologies, Inc., Charlotte, NC (US)

(72) Inventor: Alan Smith, West Moors (GB)

(21) Appl. No.: 15/551,868

(22) PCT Filed: Jan. 29, 2016
(86) PCT No.: PCT/GB2016/050202

§ 371 Date: Aug. 17, 2017

(30) Foreign Application Priority Data
Feb. 18, 2015 (GB) 1502686.7

(51) Int. Cl. F04B 1/12; F04B 9/04; F04B 15/02; F04B 17/03; F04B 53/08; F16H 25/14; F16H 53/02

(52) U.S. Cl. CPC F04B 1/128; F04B 9/042; F04B 15/02; F16H 53/02; F04B 53/08; F16H 25/14; F04B 17/03

(57) ABSTRACT

A positive displacement pump for pumping a fluid mastic comprises a plurality of cylinders each having a piston arranged for reciprocal motion within the cylinder. Movement of the piston in a first direction draws the fluid into the cylinder and movement in a second, opposite direction pumps the fluid out of the cylinder. A variable speed electric motor is drivingly coupled to a cam arrangement providing a reciprocating drive to the pistons. The cam arrangement comprises cams shaped and arranged to drive each piston in the first direction over less than half of a rotational cycle and to drive each piston in the second direction over the remainder of the rotational cycle. The cams are arranged to drive the pistons out of phase with one another.

### FIELD OF THE INVENTION

The present invention relates to a high pressure pump. More particularly, the invention relates to a pump for pumping a thick, highly viscous material such as mastic.

### BACKGROUND

Mastic materials are used increasingly as sealants in product manufacturing facilities, particularly in automotive manufacturing. Typically the mastic material will be applied to a product (e.g. parts of a vehicle) as the product is moved through different stages in the manufacturing process, for example at different stations on a production line. When required to apply the mastic, an operator will simply reach for a mastic application gun, which is connected to an off-take on a mastic circuit that is supplied with the mastic at a high pressure. The high pressure is provided by a pump. Conventionally, the pumps used have been hydraulic or pneumatic positive displacement pumps.

However, because mastics are very thick and viscous, the capacity and pressure available from conventional pumps has meant that the circuits have to be short such that the mastic pumps and the reservoirs of the mastic materials being pumped have hitherto had to be located close to the stations where the off-takes are located. A further problem is that the fluids tend to thicken, and may even solidify if left stationary for too long a time, such as overnight or at a week-end when the plant is not being used. On large production lines, these problems have meant that a large number of mastic pumping circuits have been installed close to the points where the mastic is used, with a correspondingly large number of pumps and storage vessels (reservoirs).

Another problem with the pumping of mastics in these situations has been difficulty in operating the pump at very low speeds when only a small amount of mastic is being used, while still delivering the pressure required.

Similar problems can arise with other high viscosity fluids, such as epoxy materials or other types of adhesive.

This invention has therefore been conceived to provide a pump that overcomes or alleviates the foregoing problems.

### SUMMARY

According to a first aspect of the present invention, there is provided a positive displacement pump for pumping a fluid mastic. The pump comprises a plurality of cylinders each having a piston arranged for reciprocal motion within the cylinder. Movement of the piston in a first direction draws the fluid into the cylinder and movement in a second, opposite direction pumps the fluid out of the cylinder. A variable speed electric motor is drivingly coupled to a cam arrangement providing a reciprocating drive to the pistons. The cam arrangement comprises cams shaped and arranged to drive each piston in the first direction over less than half of a rotational cycle and to drive each piston in the second direction over the remainder of the rotational cycle. The cams are arranged to drive the pistons out of phase with one another.

In embodiments, the positive displacement pump comprises three or more cylinders, wherein the cams are arranged to drive the pistons such that, at any position of the rotational cycle more than half of the pistons are being driven in the second direction. Having more than half of the pistons being driven in the second direction has the advantage that a greater piston area is used to exert force on the fluid, thereby generating a larger fluid flow. This arrangement also results in lower mechanical forces on the cam than would be the case if an equivalent fluid flow was to be produced by less than half of the pistons.

In embodiments, the cams are arranged such that a change in the direction of movement of any piston from the second direction to the first direction occurs at an angle of less than 5 (or even less than 2) degrees of rotation of the cams after another piston has changed direction from the first direction to the second direction. This provides that an increased number of pistons are pumping fluid prior to each change of direction of a piston from the second direction to the first direction.

In a piston, the change in direction at the end of a stroke does not occur instantaneously, because the piston must decelerate, before accelerating in the opposite direction. Therefore, in a conventional pump in which two pistons change direction simultaneously, there is a short time during which neither of the pistons is pumping at full pressure. This results in a brief drop in pressure of the outlet fluid. In embodiments of the invention described in the previous paragraph, for a short time, both pistons travel in the second direction, thereby reducing this pressure drop.

In embodiments, the variable speed electric motor is an ac motor. The ac motor may have an inverter, the inverter having a closed loop vector drive control. The ac motor may have a shaft encoder providing a signal indicating a position of the rotor to the inverter. The ac motor may include a forced convection fan arranged to provide cooling air to windings of the motor.

According to a second aspect of the present invention, there is provided a positive displacement pump for pumping a fluid mastic, the pump comprising a plurality of cylinders each having a piston arranged for reciprocal motion within the cylinder. Movement of the piston in a first direction draws the fluid into the cylinder and movement in a second, opposite direction pumps the fluid out of the cylinder. A variable speed ac motor is drivingly coupled to a cam arrangement providing a reciprocating drive to the pistons, wherein the ac motor has an inverter, the inverter having a closed loop vector drive control.

Embodiments described in the previous two paragraphs have the advantage that the motor can be run at very low speeds without stalling. This means that the pump can provide and maintain a high pressure to the fluid/mastic even when the quantity of mastic being used is very small (or zero). The pistons of this invention are capable of applying force to the fluid in the pump cylinders even when the pistons are not moving.

In embodiments, the ac motor has a shaft encoder providing a signal indicating a position of the rotor to the inverter.

In embodiments the ac motor includes a forced convection fan arranged to provide cooling air to windings of the motor. At normal high rotational speeds, the rotation of the windings through the air usually provides sufficient cooling to keep the windings from overheating. When the ac motor is rotating at very low speeds, or is stationary but still applying pressure to the fluid/mastic, the lack of movement means that there is no air flow past the motor windings. However, the windings continue to be supplied with a current to provide the required torque to the cams, and so will generate heat, which is removed by the air blown from the forced convection fan.

In embodiments of the first and second aspects of the invention, the cam arrangement includes a first cam and cam follower for each piston and a second cam and cam follower, 180° out of phase with the first cam and cam follower, wherein the first and second cam followers are connected to each other such that the distance between them is always the same, and the cam surfaces are shaped to ensure that the cam followers maintain contact with the respective cams at all times. This is advantageous because if contact between a follower and a cam surface is lost, even for a short time, this can give rise to a bouncing or knocking effect that increases wear of the follower and cam surfaces. Additionally, springs may urge the cam followers to maintain contact with their respective cams.

In embodiments, the cams have constant velocity cam surface profiles. An advantage of this is that the same mastic flow is achieved for a given motor rotation, regardless of the position in the cycle.

Embodiments of the present invention may comprise any of the above features taken in combination.

### BRIEF DESCRIPTION OF THE DRAWINGS

FIG. 1 is an illustration of an embodiment of a high pressure positive displacement pump.

FIG. 2 is a cross section of an embodiment of the high pressure positive displacement pump of FIG. 1.

FIG. 3a is a diagram illustrating a principle of operation of a 3-cylinder high pressure pump in a first position of an operating cycle.

FIG. 3b is a diagram of the 3-cylider high pressure pump in a second position of an operating cycle.

FIG. 4a is a diagram illustrating one principle of operation of a 5-cylinder high pressure pump.

FIG. 4b is a diagram illustrating another principle of operation of a 5-cylinder high pressure pump.

FIG. 5 is a side elevation of a section through the 3-cylinder high pressure positive displacement pump of FIGS. 2a and 2b, demonstrating a cam arrangement.

FIG. 6 is a diagram showing cam profiles of the cam arrangement of FIG. 5.

FIG. 7 is a plot showing a cam orientation diagram for a cam arrangement for the 3-cylinder high pressure pump.

FIG. 8 is a schematic diagram of a closed loop vector control system for a three-phase ac motor.

### DETAILED DESCRIPTION

In typical known installations, such as in automotive production plant, a number of positive displacement pumps are used to pump the fluid, such as a mastic or adhesive, to the plant locations where the fluid is to be used. This may involve a first pumping stage that includes a medium pressure pumping station and a second pumping stage that includes a booster station with a number of small capacity high pressure pumps.

Typically the booster station will comprise four or five or more small capacity booster pumps, each capable of delivering a relatively small amount of fluid at a high pressure, with a varying number of these pumps pumping, to match demand. The high pressure pumps are normally located close to the plant locations where the fluid is to be used.

The high pressure pumps that are described below have been developed, in part, to improve upon the known booster pumping station arrangement.

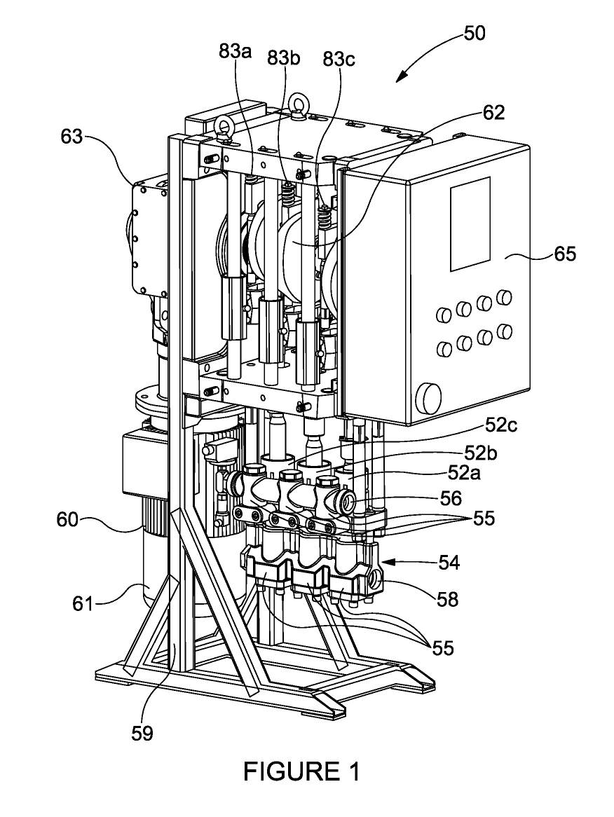

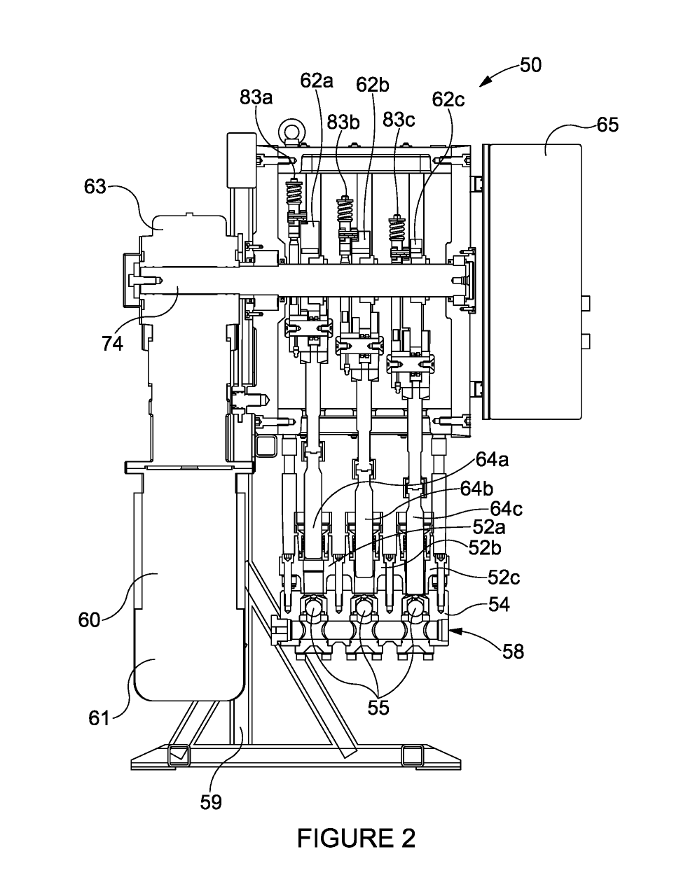

Referring to FIGS. 1 and 2, there are shown isometric and cross section views, respectively, of a positive displacement pump 50, according to an embodiment of the present invention. Positive displacement pump 50 is of a type particularly suitable as a replacement for the high pressure booster pumps described above. As shown in FIGS. 1 and 2, the positive displacement pump 50 has 3 cylinders 52a, 52b, 52c, each of which has a respective piston 64a, 64b, 64c arranged for reciprocal movement inside it. The cylinders 52a, 52b, 52c are formed in a pump body 54, in which is formed an inlet passage 58 for connection to a supply of fluid to be pumped, and an outlet passage 56 out of which the fluid is pumped. Also housed within the pump body 54 is an arrangement of check valves 55 that ensure that the fluid flows into and out of the pump in one direction as the pistons are moved within the cylinders.

The positive displacement pump 50 is shown mounted to a frame 59, which also supports a variable speed electric motor drive 60 providing a rotational drive to a cam shaft 74 of a cam arrangement 62, via a gearbox 63, and a control panel 65. The control panel 65 houses a controller configured to control the motor drive 60, including controlling the motor speed. Variable speed electric motor drive 60 also includes a forced convection fan 61. The cam arrangement 62 provides a reciprocating drive to the pistons in the cylinders 52a, 52b, 52c, in a manner explained in more detail below.

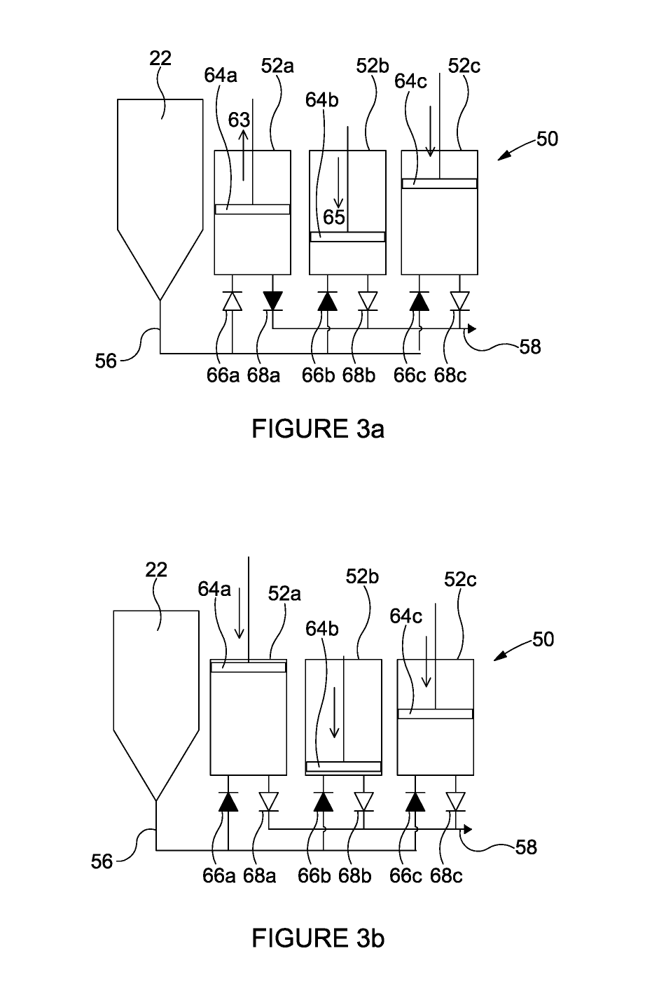

FIGS. 3a and 3b illustrate a principle of operation of the 3-cylinder positive displacement pump 50. As shown in FIGS. 3a and 3b, the positive displacement pump 50 has 3 cylinders 52a, 52b, 52c, each of which has a respective piston 64a, 64b, 64c arranged for reciprocal motion within the cylinder. Each of the cylinders 52a, 52b, 52c is connected via an inlet check valve 66a, 66b, 66c to an inlet passage 58, and via an outlet check valve 68a, 68b, 68c to an outlet passage 56.

During the reciprocal cycle, the pistons go through a drawing stroke and a pumping stroke. These strokes are described in more detail below with respect to FIG. 3a, in which one piston 64a is in the drawing stroke and two pistons 64b, 64c are in the pumping stroke.

During the drawing stroke, the piston 64a moves upwards within the cylinder 52a in the direction indicated by arrow 63. The suction of the piston 64a opens the inlet check valve 66a and closes the outlet check valve 68a. Fluid is drawn along the inlet passage 58, through the inlet check valve 66a and into the cylinder 52a.

During the pumping stroke, the pistons move downwards within the cylinders 52b, 52c in the direction indicated by arrow 65. The pistons 64b, 64c increase the pressure of the fluid, which causes the inlet check valves 66b, 66c to close and the outlet check valves 68b, 68c to open. Fluid is pumped out of the cylinders 64b 64c, through the outlet check valves and along the outlet passage 56.

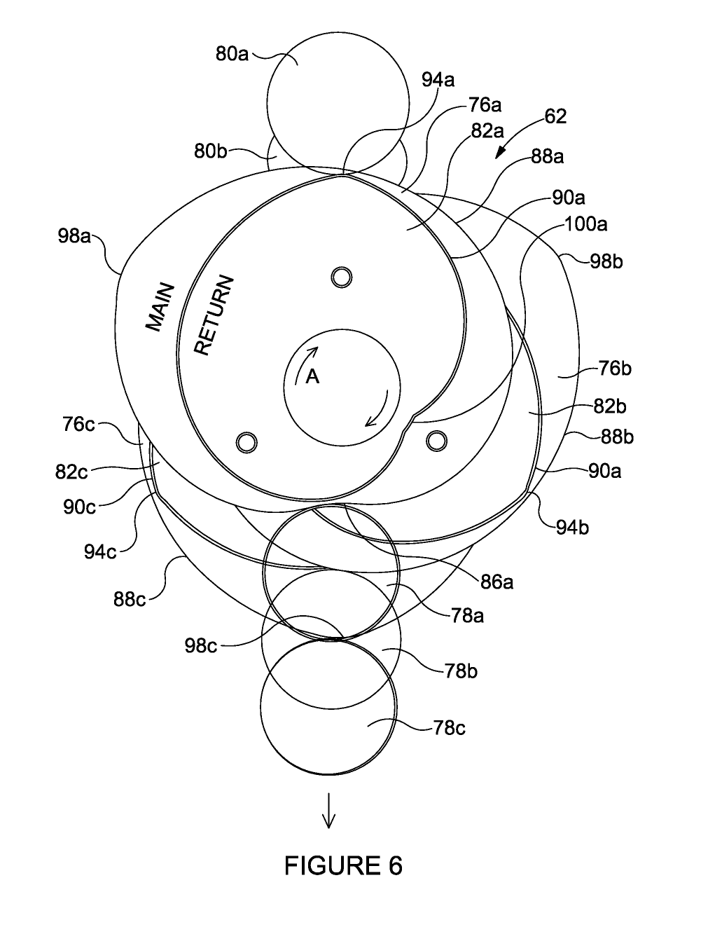

The pistons are driven by a variable speed electric motor (60) coupled to a cam arrangement (62). For the 3-cylinder pump system, the cams are shaped such that the drawing stroke occurs over a time period which is less than half the time period of the pumping stroke. The cams are arranged to drive the pistons out of phase with one another such that at any position during the rotation cycle, at least two of the pistons are pumping. This means that twice the piston area is used to exert force on the fluid, thereby generating twice the fluid flow than for a single cylinder. This arrangement also results in lower mechanical forces on the cam than would be the case if an equivalent fluid flow was to be produced by a single piston. A detailed description of the cams is given below with reference to FIG. 6.

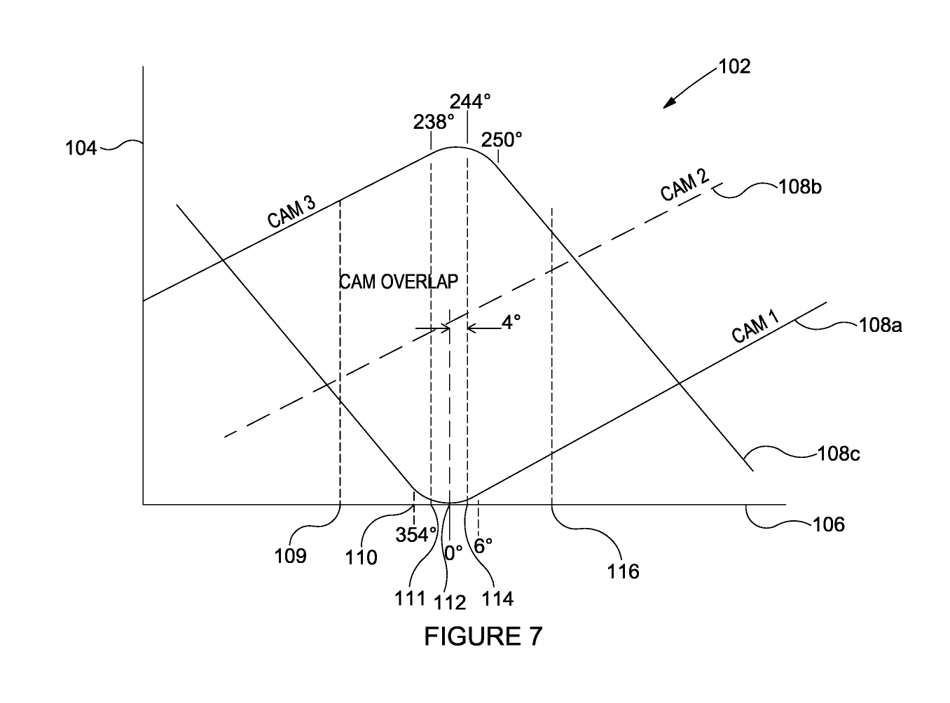

FIG. 3b shows a different point in the same 3-cylinder pump cycle, in which the three pistons 64a, 64b, 64c are all pumping. This occurs shortly after a piston (in this case 64a) finishes drawing and begins pumping. The cams are arranged in such a way that a change in direction of movement of any piston (in this case 64b) from pumping to drawing occurs a small angle of rotation of the cams after another piston (in this case 64a) has changed direction of movement from drawing to pumping. This small angle of rotation of the cams is typically less than 5 degrees and may be less than 2 degrees in some cases. Further illustration of this feature of the invention is given later in the description with reference to FIGS. 6 and 7.

In a piston, the change in direction at the end of a stroke does not occur instantaneously, because the piston must decelerate, before accelerating in the opposite direction. Therefore, in a conventional pump in which two pistons change direction simultaneously, there is a short time during which neither of the pistons is pumping at full pressure. This results in a brief drop in pressure drop of the outlet fluid. The feature of the invention described in the previous paragraph reduces the amount of this pressure drop.

The above description is for a 3-cylinder/piston pumping arrangement and (as will become clear) it is usually preferable for pumps to include three or more cylinders/pistons. However, the principles of operation could also be applied to a two-cylinder/piston arrangement, where each piston is driven by a cam having a cam profile in which more than half of the cam rotation cycle is used to drive the piston in the pumping stroke, and the remainder (less than half) of the cam rotation is used for the return stroke. For the two-cylinder arrangement this means that for part of the rotational cycle both pistons will be pumping. At other times in the cycle only one piston will be pumping while the other piston is on its return stroke. This means that the pressure or flow rate will vary throughout the cam cycle and give rise to a cyclical or “pulsing” type of flow. In many applications such types of flow are not desirable, and can be avoided using pumps with three or more cylinders/pistons as described above and below. However, there may be applications where this type of flow does not cause a problem. Therefore embodiments may also include pumps with just two cylinders/pistons. A two-cylinder arrangement of this type may still produce a higher average pressure than a two-cylinder pump in which the pistons are always 180 degrees out of phase such that only one piston is pumping at any given time.

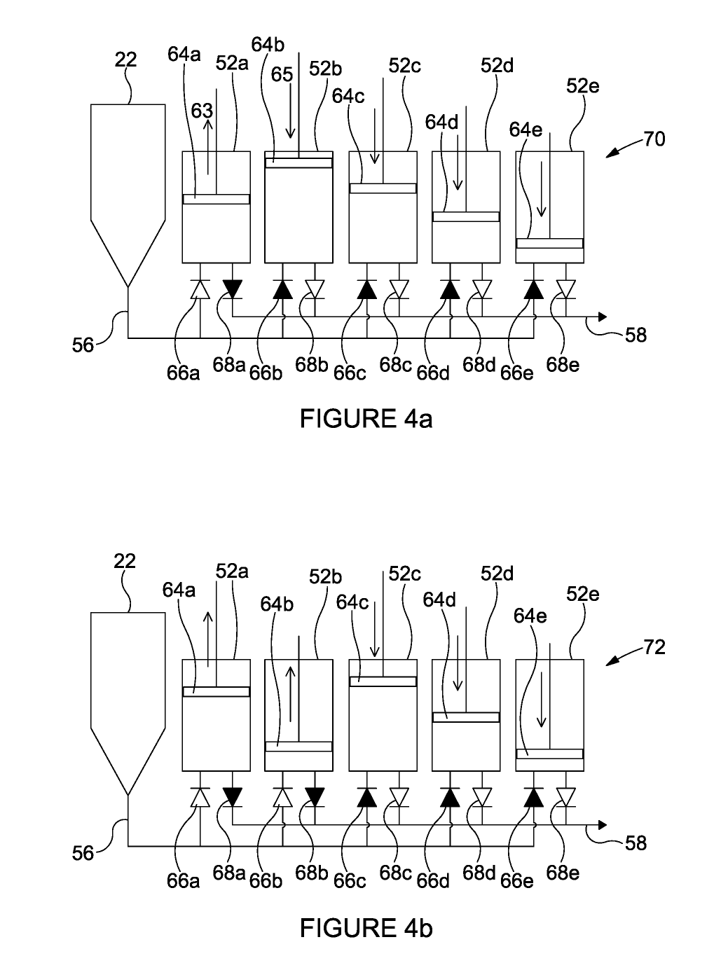

FIGS. 4a and 4b illustrate some principles of operation of a 5-cylinder positive displacement pump, as one alternative to the 3-cylinder arrangement of FIGS. 3, 3a and 3b. In both of these embodiments, the individual cylinders 52, pistons 64, inlet check valves 66 and outlet check 68 operate in the same manner as described above with respect to FIGS. 3a and 3b.

FIG. 4a illustrates a 5-cylinder positive displacement pump 70, in which the cams (not shown) are shaped such that the drawing stroke occurs over a time period which is less than a quarter the time period of the pumping stroke. The cams are arranged to drive the pistons out of phase with one another such that at any position during the rotation cycle, at least four of the pistons are pumping. At the point in the cycle shown by FIG. 4a, piston 64a is in the drawing stroke while pistons 64b, 64c, 64d, 64e are in the pumping stroke.

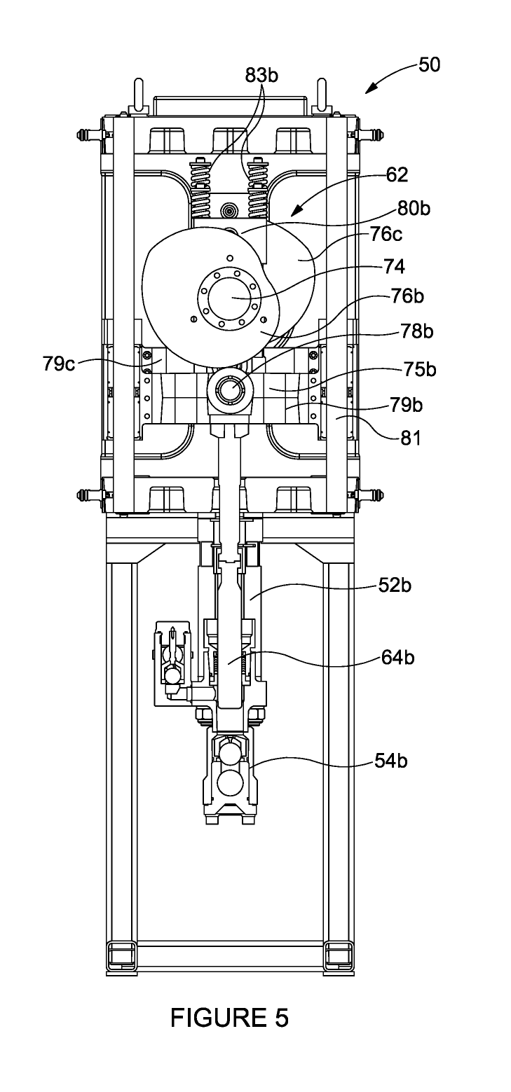

FIG. 4b illustrates a 5-cylinder positive displacement pump 72, in which the cams (not shown) are shaped such that the drawing stroke occurs over a time period which is less than two thirds the time period of the pumping stroke. The cams are arranged to drive the pistons out of phase with one another such that at any position during the rotation cycle, at least three of the pistons are pumping. At the point in the cycle shown by FIG. 5, pistons 64a, 64b are in the drawing stroke while pistons 64c, 64d, 64e are in the pumping stroke.

As in the 3-cylinder positive displacement pump arrangement, the cams in the 5-cylinder positive displacement pump 70, 72 may be arranged in such a way that a change in direction of movement of any piston from pumping to drawing occurs a small angle of rotation of the cams after another piston has changed direction of movement from drawing to pumping. Again, this small angle of rotation of the cams is typically less than 5 degrees and may be less than 2 degrees in some cases. As described above, this feature avoids the brief pressure drop in the outlet fluid which occurs when two pumps change direction simultaneously.

Referring to FIG. 5, there is shown a side elevation of a section through the 3-cylinder high pressure positive displacement pump 50 of FIGS. 1 and 2, demonstrating the cam arrangement 62 that provides actuating movement of the pistons 64, as described above with reference to FIGS. 2a, 2b, 3a and 3b. The cam arrangement 62 includes, for each of the three cylinders 52a-c, a main cam 76a-c, a return cam (not shown in FIG. 5), and a follower assembly 75a-c. The cam arrangement 62 further includes a cam shaft 74. In FIG. 5, most of the components shown relate to one of the three cylinders, 52b, although parts of some components that relate to another of the cylinders, 52c, are also visible.

Follower assemblies 75a-c each include a main follower wheel 78a-c, a return follower wheel 80a-c, a slider 79a-c, a follower frame 81a-c and a pair of springs 83a-c (see also FIGS. 1 and 2). The springs 83a-c ensure that the respective follower wheels 78a-c are urged against the surface of the rotating cams at all times and that no backlash arises as a result of any wear to the contacting surfaces. Rotation of cam shaft 74 causes translation of main follower wheel 78a-c and return follower wheel 80a-c, as is described below with reference to FIG. 6. The axes of each of the main follower wheels 78a-c and return follower wheels 80a-c are fixed to the respective slider 79a-c, which is fixed to piston 64. Follower frames 81a-c constrain the sliders 79a-c to translate linearly, resulting in axial translation of pistons 64a-c within cylinder 52.

Referring to FIG. 6, there is shown a diagram of the cam profiles of the cam arrangement 62. The cam arrangement 62 includes a cam shaft 74, to which three main cams 76a-c and three return cams 82a-c are fixed. Each of the main cams 76a-c includes a main cam surface 88a-c, which is in rolling contact with a main follower wheel 78a-c. The main follower wheels 78a-c are positioned in between the main cams 76a-c and the cylinders 52a-c. Each of the return cams 82a-c includes a return cam surface 90a-c, which is in rolling contact with one of the return follower wheels 80a-c. The return cams 82a-c are positioned in between the return follower wheels 80a-c and the cylinders 52a-c. In some embodiments, each of the main cams 76a-c is integrally formed with its corresponding return cam 82a-c. This results in three integral cam components, one for each piston/cylinder, each of which has a main cam surface 88a-c and a return cam surface 90a-c, with the surfaces offset from each other along the direction of the axis of the cam shaft 74.

The main cam surfaces 88a-c includes a main cam top displacement point 86a-c and a main cam bottom displacement point 98a-c. Each of the return cam surfaces 90a-c includes a return cam top displacement point 94a-c and a return cam bottom displacement point 100a-c.

At the point in the cycle shown in FIG. 6, piston 64a, which is associated with main cam 76a and return cam 82a, is at its top position in cylinder 52a. This means that piston 64a is about to begin its pumping phase. At this point, the main cam top displacement point 86a is in contact with the main follower wheel 78a, and at this point the main cam radius is at its minimum. The return cam top displacement point 94a is in contact with return follower wheel 80a, and at this point the return cam radius is at its maximum.

During the pumping phase of the piston 64a, the main cam surface 88a remains in contact with main follower wheel 78a. The cam shaft 74, and the main cams 76a-c and return cams 82a-c rotate in the direction shown by the arrow A.

At the beginning of the pumping phase of the piston 64a, when the piston is at its top position within cylinder 52a, the translational velocities of the piston 64a and the main follower wheel 78a are instantaneously zero. For the majority of the pumping phase, the main cam radius at the point of contact with main follower wheel 78a increases linearly with rotation of the cam shaft 74, resulting in constant downwards translational velocity of the main follower wheel 78a, and corresponding motion of the piston 64a within the cylinder 52a. However, the linear increase in main cam radius cannot be achieved close to the main cam top displacement point 86a, as the main cam surface 88a is shaped to accommodate the main follower wheel 78a (which has a finite radius) at this point. Therefore, at the beginning of the pumping phase, the piston 64a accelerates over a short time period from zero to the constant velocity described above.

Following the acceleration described in the previous paragraph, the piston 64a continues to travel at constant velocity until close to the end of the pumping phase, when the cam shaft 74 has rotated through approximately 240 degrees and the main cam bottom displacement point 98a has almost reached the main follower wheel 78a. The piston 64a decelerates from its constant velocity to zero over a short time period, until the main cam bottom displacement point 98a has reached the main follower 78a, at the end of the pumping phase of piston 64a. The main cam radius is at its maximum when the follower wheel is in contact with main cam bottom displacement point 98a.

At the end of the pumping phase of the piston 64a, the piston 64a is at its bottom position within cylinder 52a, and has instantaneously zero velocity. The return cam bottom displacement point 100a is in contact with return follower wheel 80a, and the return cam radius is at its minimum.

Following the pumping phase of the piston 64a, the drawing phase begins. During the drawing phase, return cam surface 90a remains in contact with return follower wheel 80a. The cam shaft 74, and the main cams 76a-c and return cams 82a-c continue to rotate in the direction shown by the arrow A.

At the beginning of the drawing phase of the piston 64a, when the piston is at its bottom position within cylinder 52a, the translational velocities of the piston 64a and the return follower wheel 82a are instantaneously zero. For the majority of the drawing phase, the return cam radius 96a at the point of contact with return follower wheel 80a increases linearly with rotation of the cam shaft 74, resulting in constant velocity upwards translation of the return follower wheel 80a, and corresponding upwards motion of the piston 64a within the cylinder 52a. However, constant velocity cannot be maintained close to the return cam bottom displacement point 100a, as the return cam surface 88a is shaped to accommodate the return follower wheel 80a (which also has finite radius) at this point. Therefore, instantaneous deceleration and acceleration cannot be achieved. Therefore, at the beginning of the drawing phase, the piston 64a accelerates over a short time period from zero to the constant velocity described above.

Following the acceleration described in the previous paragraph, the piston 64a continues to travel at this constant velocity until near to the end of the drawing phase, when the cam shaft 74 has rotated through a further approximately 120 degrees and the return cam top displacement point 94a has almost reached the return follower wheel 80a. The piston 64a decelerates from the constant velocity to zero over a short time period, until the return cam top displacement point 94a is in contact with the return follower wheel 80a, at the end of the drawing phase of piston 64a, in the position shown in FIG. 6. Again, an instantaneous deceleration cannot be achieved at the return cam top displacement point 94a.

The main cams 76a-c and return cams 82a-c are shaped such that the constant speed at which the pistons 64a-c travel during the pumping phase is approximately half of the constant speed at which the pistons travel during the drawing phase. Main cams 76b, 76c and return cams 82b, 82c operate in the same manner as main cam 76a and return cam 82a described above. At all points during the cycle, main cam 76a and return cam 82a are 120 degrees out of phase with main cam 76b and return cam 82b, respectively. Main cam 76b and return cam 82b are 120 degrees out of phase with main cam 76c and return cam 82c, respectively. This gives the actuating movement of the pistons 64a, 64b, 64c described above with reference to FIGS. 3a and 3b.

Note that there are constant velocity profiles for both stroke directions of both the main cams and the return cams. It might seem that a constant velocity profile is unnecessary for the return cam when the main cam is driving the piston on the pumping stroke (or equally that a constant velocity profile is unnecessary for the main cam during the return stroke). However the constant velocity profiles ensure that the followers maintain contact with the cam surfaces for the entire 360-degree rotational cycle, because the springs 83a-c urge each of the followers to their cam. This is advantageous because if contact between a follower and a cam surface is lost, even for a short time, this can give rise to a bouncing or knocking effect that increases wear of the follower and cam surfaces.

Referring to FIG. 7, there is shown a cam orientation diagram 102 for a cam arrangement 62 for the 3-cylinder high pressure pump 50. Cam orientation diagram 102 plots cam displacement 104 against cam rotation 106. In FIG. 7, the direction of rotation of the cams is from left to right along the graph axis of cam rotation 106. A positive cam displacement corresponds to downward motion of pistons 64 within cylinders 52. A single curve 108a, 108b, 108c is given for each combination of main cam 76a, 76b, 76c and return cam 82a, 82b, 82c associated with each piston 64a, 64b, 64c.

At first cam rotation angle 109, curve 108a has a negative gradient, indicating that piston 64a is travelling upwards in cylinder 52a, in its drawing phase. Curves 108b and 108c have positive gradients, indicating that pistons 64b and 64c are both travelling downwards in cylinders 52b, 52c, during their pumping phases. This is as described above with respect to FIG. 3a.

As all of the curves 108a-c have constant gradients at first cam rotation angle 109, all of the pistons 64 are travelling at constant velocities. The magnitude of the gradient of curve 108a is double that of curves 108b, 108c, indicating that piston 64a is travelling at double the speed of pistons 64b, 64c.

As cam rotation angle increases from first cam rotation angle 109, pistons 64a, 64b, 64c continue to travel at the same constant velocities until second cam rotation angle 110 is reached. At this angle, the negative gradient of curve 108a begins to increase, indicating that the speed of piston 64a is falling. The reason for this is explained above with respect to FIG. 6.

As cam rotation angle increases from second cam rotation angle 110, the speed of piston 64a continues to fall, while pistons 64b, 64c continue travelling at the same constant velocities, until third cam rotation angle 111 is reached. At this angle, the positive gradient of curve 108c begins to decrease, indicating that the speed of piston 64c is also falling. Again, the reason for this is explained above with respect to FIG. 6.

As cam rotation angle increases from third cam rotation angle 111, piston 64b continues travelling at the same constant velocity, while the speeds of pistons 64a, 64c continue to fall, until fourth cam rotation angle 112 is reached. At this angle, curve 108a is at its minimum cam displacement, indicating that piston 64a is instantaneously stationary at the top of cylinder 52a, having just completed its drawing phase. Again, curves 108b and 108c have positive gradients, indicating that pistons 64b 64c are in their pumping phases.

As cam rotation angle increases from fourth cam rotation angle 112, the gradient of curve 108a begins to increase, indicating that piston 64a is accelerating in the downwards direction at the beginning of its pumping phase, while piston 64b continues travelling at the same constant velocity. The gradient of curve 108c remains positive until fifth cam rotation angle 114 is reached. At fifth cam rotation angle 114, curve 108c is at its maximum cam displacement, indicating that piston 64c is instantaneously stationary at the bottom of cylinder 52c, having just completed its pumping phase. This means that in between fourth cam rotation angle 112 and fifth cam rotation angle 114, all three curves 108a, 108b, 108c have positive gradients, indicating that all three pistons 64a 64b 64c are pumping, as is described above with respect to FIG. 3b. This occurs in this case because the pumping phase takes place over 244 degrees of cam rotation, while the drawing phase takes place over 116 degrees of cam rotation.

Cam rotation angle increases further up to sixth cam rotation angle 116. At this angle, curves 108a, 108b have constant positive gradients, indicating that pistons 64a, 64b are both travelling downwards at constant velocity in cylinders 52a, 52b, as part of their pumping phases. Curve 108c has a constant negative gradient, indicating that piston 64c is travelling upwards at constant velocity in cylinder 52c, in its drawing phase.

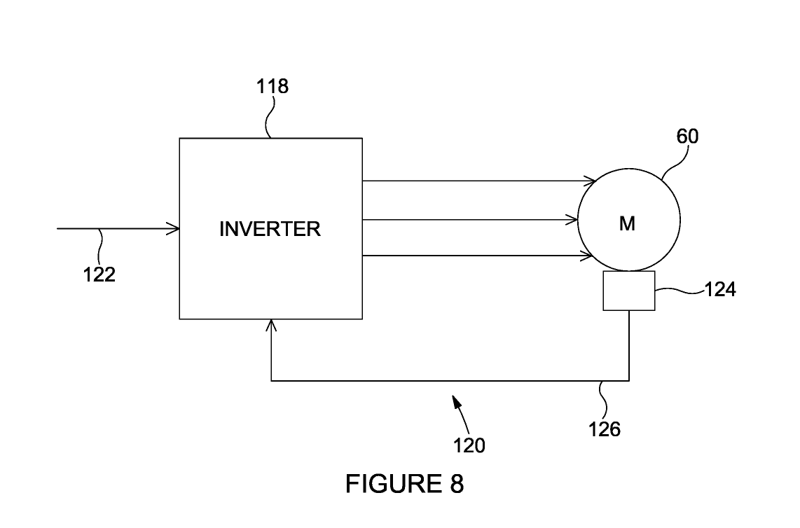

The variable speed electric motor 60, which drives the cam arrangement as described above so as to provide a reciprocating drive to the pistons, may be any type of electric motor capable of being controlled to vary its speed. However, embodiments may utilise a variable speed ac motor. A particularly advantageous arrangement utilises a variable speed ac motor. As shown in FIG. 8, the variable speed ac motor drive may be controlled by the controller, which has an inverter 118 with a closed loop vector drive control 120. When an ac motor runs at relatively high speed, although there is some slippage between the stator and rotor positions relative to the phase angle of the ac drive current, this slippage can be tolerated because it is usually only a small angle provided the drive torque is not excessive. Thus, in the vast majority of ac motor drive applications no adjustment needs to be made for this slippage, and the inverter used to control the current supplied to the motor windings operates using an open-loop vector control. However, such motors are not suitable for operation at very low speeds, as the slippage can cause the motor to stall. For most applications this is not a problem, but for the pumps described above, such as pumps for pumping mastic, it is required to provide and maintain a high pressure to the fluid/mastic even when the quantity of mastic being used is very small (or zero). This means that the pumps 24, 26 must be capable of maintaining a high pressure—or in other words that the pistons of the positive displacement pumps continue to apply force to the fluid in the pump cylinders even when the pistons are not moving. Therefore the ac motor 60 must maintain a torque on the cam shaft even when this is not rotating, and this can only happen if the ac motor does not stall. Accordingly, the ac motor 60 inverter uses a closed loop vector control.

Referring to FIG. 8, there is shown a schematic diagram of a closed loop vector control system 120 for a three-phase ac motor 60, which may be used to drive the pump 50, 70. The closed loop vector control system 120 includes an inverter 118 connected to the three phases of the motor 60. The motor 60 includes a feedback device 124, which is connected to the inverter 118 by a feedback loop 126.

In closed loop vector control 120, a reference signal 122 is passed to inverter, to specify the desired motor speed. The feedback device 124 measures the position and speed of the motor 60. This measured speed and position is passed to inverter 118 via feedback loop 126. The inverter 118 uses the position measurement to determine which phase of the motor 60 requires current at a particular time. The inverter 118 also compares the measured motor speed to the desired speed, to determine the current to be provided to the motor 60. There are a number of different ways that feedback device 124 can determine the motor position and speed. As but one example, the ac motor 60 may have a shaft encoder that provides a signal to the inverter.

Another beneficial feature of the ac motor 60 is a forced convection fan arranged to provide cooling air to windings of the motor. At normal high rotational speeds, the rotation of the windings through the air usually provides sufficient cooling to keep the windings from overheating. When the ac motor 60 is rotating at very low speeds, or is stationary but still applying pressure to the fluid/mastic, the lack of movement means that there is no air flow past the motor windings. However, the windings continue to be supplied with a current to provide the required torque to the cams, and so will generate heat, which is removed by the air blown from the forced convection fan 61.

Embodiments of the invention may provide for a particularly advantageous arrangement in that a single high pressure pump may be used, rather than the four or more low capacity high pressure pumps which are typically used in known systems. This is because the high pressure pump can operate over a much larger range of flow rates than existing pumps, allowing the single high pressure pump to provide all of the flow rates required.

The pump 50 and its controller keep the pressure at the outlet of the pump 50 at a pre-set value, independent of the flow rate of the pump, as in a true pressure closed loop control system. For example, a pressure sensor (not shown) may be used to provide a pressure signal to the controller for this purpose. In the known systems referred to above, the smaller capacity pumps only start to pump when the pressure in the line at the outlet of the pumps drops, with flow increasing as the pressure continues to drop. This leads to the dynamic pressure in the system being much lower than the static pressure, which has a detrimental effect on the system and the process.

1. A positive displacement pump suitable for pumping a fluid mastic, the pump comprising:
a plurality of cylinders each having a piston arranged for reciprocal motion within the cylinder, whereby movement of the piston in a first direction draws the fluid into the cylinder and movement in a second, opposite direction pumps the fluid out of the cylinder; and
a variable speed electric motor drivingly coupled to a cam arrangement providing a reciprocating drive to the pistons,
wherein the cam arrangement comprises cams shaped and arranged to drive each piston in the first direction over less than half of a rotational cycle and to drive each piston in the second direction over the remainder of the rotational cycle, and
wherein the cams are arranged to drive the pistons out of phase with one another.

2. The positive displacement pump of claim 1, comprising three or more cylinders, wherein the cams are arranged to drive the pistons such that, at any position of the rotational cycle more than half of the pistons are being driven in the second direction.

3. The positive displacement pump of claim 1, wherein the cams are arranged such that a change in the direction of movement of any piston from the second direction to the first direction occurs at an angle of less than 5 degrees of rotation of the cams after another piston has changed direction from the first direction to the second direction, thereby providing that an increased number of pistons are pumping fluid prior to each change of direction of a piston from the second direction to the first direction.

4. The positive displacement pump of claim 3, wherein the angle of less than 5 degrees of rotation of the cams is an angle of less than 2 degrees.

5. The positive displacement pump of claim 1, wherein the variable speed electric motor is an ac motor.

6. The positive displacement pump of claim 5, wherein the ac motor has an inverter, the inverter having a closed loop vector drive control.

7. The positive displacement pump of claim 6, wherein the ac motor has a shaft encoder providing a signal indicating a position of the rotor to the inverter.

8. The positive displacement pump of claim 6 wherein the ac motor includes a forced convection fan arranged to provide cooling air to windings of the motor.

9. A positive displacement pump suitable for pumping a fluid mastic, the pump comprising:
a plurality of cylinders each having a piston arranged for reciprocal motion within the cylinder, whereby movement of the piston in a first direction draws the fluid into the cylinder and movement in a second, opposite direction pumps the fluid out of the cylinder; and
a variable speed ac motor drivingly coupled to a cam arrangement providing a reciprocating drive to the pistons, wherein the ac motor has an inverter, the inverter having a closed loop vector drive control.

10. The positive displacement pump of claim 9, wherein the ac motor has a shaft encoder providing a signal indicating a position of the rotor to the inverter.

11. The positive displacement pump of claim 9 wherein the ac motor includes a forced convection fan arranged to provide cooling air to windings of the motor.

12. The positive displacement pump of claim 9, wherein the cam arrangement comprises cams shaped and arranged to drive each piston in the first direction over less than half of a rotational cycle and to drive each piston in the second direction over the remainder of the rotational cycle, and
wherein the cams are arranged to drive the pistons out of phase with one another.

13. The positive displacement pump of claim 12, comprising three or more cylinders, wherein the cams are arranged to drive the pistons such that, at any position of the rotational cycle more than half of the pistons are being driven in the second direction.

14. The positive displacement pump of claim 12, wherein the cams are arranged such that a change in the direction of movement of any piston from the second direction to the first direction occurs at an angle of less than 5 degrees of rotation of the cams after another piston has changed direction from the first direction to the second direction, thereby providing that an increased number of pistons are pumping fluid prior to each change of direction of a piston from the second direction to the first direction.

15. The positive displacement pump of claim 14 wherein the angle of less than 5 degrees of rotation of the cams is an angle of less than 2 degrees.

16. The positive displacement pump of claim 9, wherein the cam arrangement includes a first cam and cam follower for each piston and a second cam and cam follower, 180° out of phase with the first cam and cam follower, wherein the first and second cam followers are connected to each other such that the distance between them is always the same, and the cam surfaces are shaped to ensure that the cam followers maintain contact with the respective cams at all times.

17. The positive displacement pump of claim 16, wherein springs urge the cam followers to maintain contact with their respective cams.

18. The positive displacement pump of claim 9, wherein the cam arrangement comprises cams having constant velocity cam surface profiles.
